(19) United States
(12) Patent Application Publication
(10) Pub. No.: US 2008/0244293 A1
(43) Pub. Date: Oct. 2, 2008

(54) Methods, Systems, And Computer Program Products For Providing For Automatically Closing Application Widgets Based On Markup Language Elements

(76) Inventor: Robert P. Morris, Raleigh, NC (US)

Correspondence Address: SCENERA RESEARCH, LLC, 111 CORNING RD., SUITE 220, CARY, NC, 27518, US

(21) Appl. No.: 11/693,220

(22) Filed: Mar. 29, 2007

(51) Int. Cl. G06F 1/00

(52) U.S. Cl. 713/324

(57) ABSTRACT

Methods and systems are described for providing for automatically closing application widgets based on markup language elements. In one embodiment, a markup element defined in a markup language to specify a condition for automatically closing the first widget is detected while processing a resource for presentation in a widget. It is determined without using executable code included in the resource whether the condition for automatically closing the widget is satisfied. The widget is automatically closed responsive to the condition for automatically closing the widget being satisfied. In another embodiment, a resource including a markup element defined in a markup language to specify a condition for automatically closing a widget that presents the resource is provided by a first network entity to a second network entity that is one of a client and a server.

### BACKGROUND

Internet connectivity has become a necessity for the dissemination of information. So called “Web browsing” has become one of the most important means for gathering information, performing transactions, and other network-based operations. During browsing, a page is displayed in a widget, such as a window, tab, and/or pane, using a browser or other network-compatible application. Many pages contain links that when activated result in the opening of a second widget that provides information related to the first widget. For example, while browsing, one can often click on a link associated with an image or the image itself to cause a second widget to open with a larger view of the image. The user must close each of these widgets manually even though their use is temporary (often seconds). If the widgets aren't closed, a large number of open widgets can accumulate, which creates a great deal of clutter.

In some cases, these concerns have been addressed by the use of executable code included with the page, such as scripts. The use of scripts, however, are generally undesired since they can be, and are often used for creating malicious software that threatens the security, privacy, and data integrity of resources on a device processing a malicious script.

Accordingly, there exists a need for methods, systems, and computer program products for providing for automatically closing application widgets based on markup language elements.

### SUMMARY

Methods and systems are described for providing for automatically closing application widgets based on markup language elements. In one embodiment, a markup element defined in a markup language to specify a condition for automatically closing the first widget is detected while processing a resource for presentation in a first widget. It is determined without using executable code included in the resource whether the condition for automatically closing the first widget is satisfied. The first widget is automatically closed responsive to the condition for automatically closing the first widget being satisfied.

In another embodiment, a resource including a markup element defined in a markup language to specify a condition for automatically closing a widget that presents the resource is provided by a first network entity. The resource is provided to a second network entity that is one of a client for presenting the resource and a server for providing the resource to a client for presenting the resource.

In another embodiment, a system for providing for automatically closing application widgets based on markup language elements includes: means for detecting, while processing a resource for presentation in a first widget, a markup element defined in a markup language to specify a condition for automatically closing the first widget; means for determining, without using executable code included in the resource, whether the condition for automatically closing the first widget is satisfied; and means for automatically closing the first widget responsive to the condition for automatically closing the first widget being satisfied.

In another embodiment, a system for providing for automatically closing application widgets based on markup language elements includes: a markup detector component configured for detecting, while processing a resource for presentation in a first widget, a markup element defined in a markup language to specify a condition for automatically closing the first widget; a content controller component configured for determining, without using executable code included in the resource, whether the condition for automatically closing the first widget is satisfied; and a presentation manager component configured for automatically closing the first widget responsive to the condition for automatically closing the first widget being satisfied.

In another embodiment, a system for providing for automatically closing application widgets based on markup language elements includes: means for providing, by a first network entity, a resource including a markup element defined in a markup language to specify a condition for automatically closing a widget that presents the resource; and means for providing the resource to a second network entity, wherein the second network entity is one of a client for presenting the resource and a server for providing the resource to a client for presenting the resource.

In another embodiment, a system for providing for automatically closing application widgets based on markup language elements includes: a markup detector component configured for providing, by a first network entity, a resource including a markup element defined in a markup language to specify a condition for automatically closing a widget that presents the resource; and a communications manager component configured for providing the resource to a second network entity, wherein the second network entity is one of a client for presenting the resource and a server for providing the resource to a client for presenting the resource.

In another embodiment, a computer readable medium including a computer program, executable by a machine, for providing for automatically closing application widgets based on markup language elements includes executable instructions for: detecting, while processing a resource for presentation in a first widget, a markup element defined in a markup language to specify a condition for automatically closing the first widget; determining, without using executable code included in the resource, whether the condition for automatically closing the first widget is satisfied; and automatically closing the first widget responsive to the condition for automatically closing the first widget being satisfied.

In another embodiment, a computer readable medium including a computer program, executable by a machine, for providing for automatically closing application widgets based on markup language elements includes executable instructions for: providing, by a first network entity, a resource including a markup element defined in a markup language to specify a condition for automatically closing a widget that presents the resource; and providing the resource to a second network entity, wherein the second network entity is one of a client for presenting the resource and a server for providing the resource to a client for presenting the resource.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a flow diagram illustrating a method for providing for automatically closing application widgets based on markup language elements according to an embodiment of the subject matter described herein;

FIG. 2 is a block a diagram illustrating a system for providing for automatically closing application widgets based on markup language elements according to another embodiment of the subject matter described herein;

FIG. 3 is a block a diagram illustrating another system for providing for automatically closing application widgets based on markup language elements according to another embodiment of the subject matter described herein;

FIG. 4 is a flow diagram illustrating a method for providing for automatically closing application widgets based on markup language elements according to another embodiment of the subject matter described herein;

FIG. 5 is a block diagram illustrating a system for providing for automatically closing application widgets based on markup language elements according to another embodiment of the subject matter described herein; and

FIG. 6 is a block diagram illustrating another system for providing for automatically closing application widgets based on markup language elements according to another embodiment of the subject matter described herein.

### DETAILED DESCRIPTION

A “widget” as used in this document is any media presentation resource or set of media presentation resources used in association with presenting a resource. For example, for a visual resource such as a web page, a window, pane, or tab are some examples of a widget. For an audio resource, examples include a channel or an instance of an audio player. Similarly, for tactile resources, a widget can be a hardware control or housing through which a resource is presentable. One method of ending the presentation of the content presented by the widget is to close the widget. For example, a window, tab, or pane can be closed to end the presentation.

Portions of the description make reference to a declarative markup language or simply a markup language. Procedural programming requires that the programmer tell the computer what to do (i.e., how to produce an output given one or more inputs). A programmer is required to know or create a suitable algorithm. Using declarative programming, however, a developer uses the predefined relationships between the entities used and their purpose. That is, a developer knows, and must abide by the assigned structure and meaning of the markup elements because it is predefined. Declarative markup languages are thus inherently safer than procedural programming languages, since declarative languages have no direct control over a processor or system resources, as opposed to procedural languages. For example, receiving and displaying hypertext markup language (HTML) is a relatively safe operation when compared to receiving HTML including one or more scripts written in Javascript. Javascript is a procedural language and can be used in creating malicious software that threatens the security, privacy, and data integrity of resources on a device processing a malicious script. HTML poses little if any threat when used without a procedural language retrieved from a remote computer (e.g., scripts).

A markup language establishes a vocabulary, grammar, and syntax of codes, referred to as “elements” in this document, that provide extra information about the content of a resource. The extra information can include, for example, information about the structure of the resource, information about the presentation of the resource, and/or information that constitutes metadata associated with the resource. The codes or elements of a markup language are typically intermingled within the content of a resource. A markup language can provide elements applicable to text, image, video, or other forms of data included in and/or referenced by a resource using the markup language.

Perhaps the most widely known markup language is HTML, which exists in several versions and variants. Other well-known markup languages include standard generalized markup) language (SGML) from which HTML is derived, extensible markup language (XML), DocBook, mathematical markup language (MathML), scalable vector graphics (SVG), resource description framework (RDF), binary XML, wireless markup language (WML), synchronized multimedia integration language (SMIL), and many more.

A tag is a markup language label that is recognizable by a markup language processor as markup as opposed to resource content. For example, in XML, tags are indicated by the symbols, ‘<’ and ‘>’. Tags can be made up of an opening tag and closing tag as in: <p>content</p>, where the <p> tag indicates a paragraph and the </p> indicates the end of the paragraph and where <p> is the opening tag and </p> is the closing tag. Everything in between is considered to be content of the <p> tag. Tags can also be expressed as a single unit, such as: <br/>, which in HTML indicates that a line break should be inserted in the content at the location indicated by the <br/> tag.

A tag can have one or more attributes that modify the meaning or processing of the tag. For example, <p id=“0001” text=“content”/> is the same <p> tag as before with two attributes. The id attribute provides, through an assigned value, an identifier for the tag in which it is used. The identifier in this example is “0001” and should be unique for all tags used in the same resource. The text attribute provides an alternate mechanism for providing paragraph content. The value of the text attribute is the paragraph and is equivalent to <p>content</p>. Tags, attributes, values, and the syntactic symbols are all elements of the markup language.

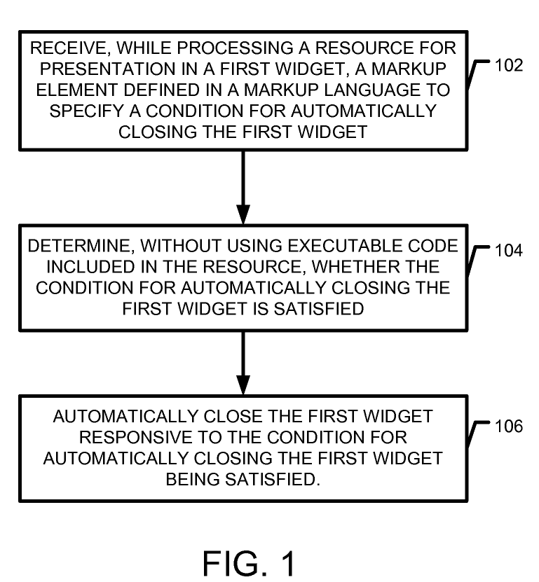

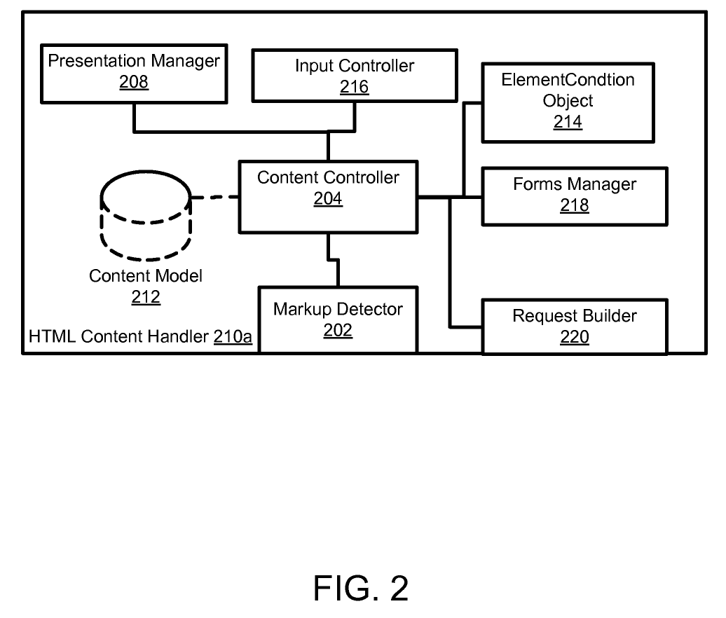

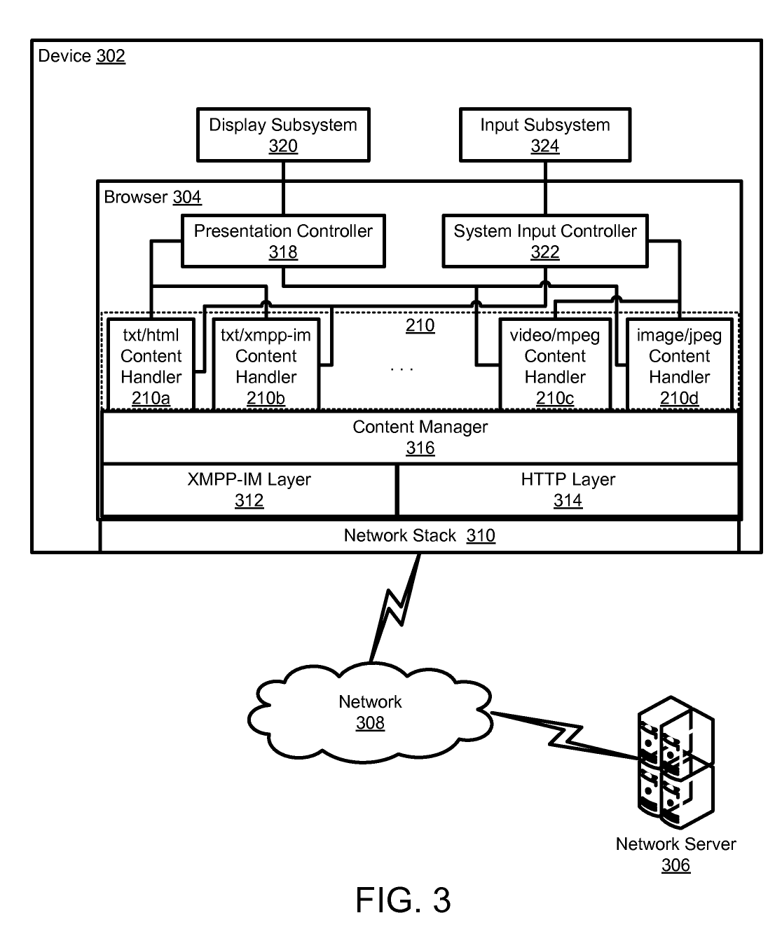

FIG. 1 is a flow diagram illustrating a method for providing for automatically closing application widgets based on markup language elements according to an exemplary embodiment of the subject matter described herein. FIG. 2 is a block diagram illustrating a system for providing for automatically closing application widgets based on markup language elements according to another exemplary embodiment of the subject matter described herein. FIG. 3 is a block diagram illustrating an exemplary system that includes the system of FIG. 2. The method illustrated in FIG. 1 can be carried out by, for example, some or all of the components illustrated in the exemplary systems of FIGS. 2 and/or 3.

The exemplary systems of FIGS. 2 and 3 are described below in terms of web-based markup languages including variants of HTML and XML. It should, however, be understood that many markup languages exist for creating text-based content, as well as media-based content, including audio- and image-based content. In addition, a number of markup languages can be used together to specify a presentable resource. In addition to markup languages based on open standards, many proprietary markup languages are also currently in use, including for example ADOBE's FLASH. The exemplary systems of FIGS. 2 and 3 can be embodied such that they are configured to perform the method of FIG. 1 with respect to any markup-based language. Thus, any of these markup languages and appropriate variations of the systems for performing the methods described herein with respect to these markup languages is intended to be embraced by the subject matter described herein.

With reference to FIG. 1, in block 102 a markup element defined in a markup language to specify a condition for automatically closing the first widget is detected while processing a resource for presentation in a first widget. Accordingly, a system for providing for automatically closing application widgets based on markup language elements includes means for detecting, while processing a resource for presentation in a first widget, a markup element defined in a markup language to specify a condition for automatically closing the first widget. For example, as illustrated in FIG. 2, a markup detector component 202 is configured for detecting, while processing a resource for presentation in a first widget, a markup element defined in a markup language to specify a condition for automatically closing the first widget.

By way of example, system 200 includes an HTML content handler 210a for use in browsers and other applications for processing various versions of HTML data. A number of multipurpose Internet mail extension (MIME) types are associated with resources, such as HTML, extensible messaging and presence protocol (XMPP), RDF, and other XML derivatives. A number of media MIME types have at least portions that are markup language bases, for example, some version of motion pictures experts group (MPEG) supports a metadata stream based on a markup language, joint photographic experts group (JPEG) files may include markup based data, and X3D is used for rendering graphics as is SMIL. The illustrative HTML content handler 210a is configured to process resources based on markup elements of a particular language or family of languages, such as variants of HTML. The use of HTML and a corresponding HTML content handler 210a is purely illustrative and should not be considered limiting. Other content handlers and executables providing analogous function for processing resources based on markup languages not explicitly mentioned can be used and typically operate in an analogous manner as is described herein. As such, they are considered to be embraced by the subject matter described in this document.

In one aspect of the subject matter disclosed, the markup element is detected through processing a markup-language-based page for presentation in a widget of a browser. For example, the markup detector 202 component can be configured for detecting a markup element through processing a markup-language-based page for presentation in a widget of a browser. In another aspect, detecting a markup element includes detecting the markup element through processing a streaming media resource including markup defined in the markup language. For example, the markup detector component 202 can be configured for detecting a markup language element through processing a streaming media resource including markup defined in the markup language.

In the current example, the HTML content handler 210a receives a resource that includes HTML markup elements. For example, the resource may have a MIME type of text/html and may include content contained within one or more HTML elements, such as <H1> and <p>. Most web pages are based on a variant of an HTML markup language, such as extensible HTML (XHTML), which is a variant that is an XML markup language. The resource is received by the markup detector 202. The resource may be received as a whole, but often is received as a stream of bytes that the markup detector 202 processes as it is received. The markup detector 202 processes the resource to detect markup elements. For example, a markup detector known as a simple application programming interface for XML (SAX) markup detector is suitable for processing (e.g., parsing) any form of XML content dynamically as received. As markup elements are detected, corresponding event handlers in a content controller component 204 can be invoked. The content controller component 204 can use the detected markup elements and the order in which the event handlers are invoked to build a model of the resource, which is stored in a content model 212. For XML-based resources, a document object model (DOM) can be used to build and interact with the content model 212. Alternatively, a content handler 210 can receive an entire resource prior to initiating detection of markup elements.

In another aspect, detecting a markup element in block 102 can include detecting a tag and/or attribute for a tag. The tag and/or attribute for a tag are defined to specify a condition for automatically closing the first widget. For example, the markup detector component 202 can be configured for detecting a tag and/or attribute for a tag defined to specify a condition for automatically closing the first widget. In the current example, HTML can be extended with a new element for specifying a condition for automatically closing a widget associated with the presentation of the resource such as a browser window, tab, or pane when the specified condition is met. The <end/> element can be included with or without attributes in the resource in any location in the resource. In system 200, the <end/> element is detected by the markup detector 202 and the content controller component 204 is provided with the element information including the element name along with any attributes and content of the element.

In another aspect, detecting a markup element in block 102 can include detecting a markup element that identifies a policy defining a condition or conditions for automatically closing the first widget. For example, the markup detector component 202 can be configured for detecting a markup language element that identifies a policy defining a condition for automatically closing the first widget. The policy can be user-specified or predefined. For example, the markup detector component 202 can be configured for receiving user input to a form associated with the resource for specifying the policy. When a policy is not specified, the condition or conditions for automatically closing the first widget can be default conditions specified by definition in the markup language and/or configurable by a browser and/or a user.

Returning to the current example, the processing of the <end/> element can be modified using application-based or user-specified policies, and/or by the use of attributes in the <end/> element. The use of attributes provides the resource developer with more power while the use of application and/or user-specified policies provide the client and/or the user with more control. The use of both techniques may also be supported. One form of application-based policy uses rules of the markup language to establish application policy in determining a condition for automatically ending the presentation of a resource including an <end/> element. The rules of the markup language require compliant applications to process the <end/> element or an analog based on rules that are not configurable by either a developer of the application or a user of the processing application except as allowed by the rules. A mix of application-based policies, user-specified policies, and/or fixed language-based policies can be used.

An <end/> element, in one example, can have an associated application-based and/or user-specifiable policy indicating to the content handler 210a that the widget presenting the resource including the element is to be closed when a specified event is detected or a condition associated with the widget or its content is detected. A “close-context” attribute can be used to indicated that the widget should be closed using a syntax similar to <end close-context=“TRUE”/>.

In another aspect, a markup element is detected that is defined to specify a condition associated with at least one of another markup element in the resource, another presentable resource, another markup element in another resource, and a request associated with the resource. For example, the markup detector component 202 can be configured for detecting a markup language element that is defined to specify a condition associated with at least one of another markup language element in the resource, another presentable resource, another markup language element in another resource, and a request associated with the resource. In example, a specified event or condition associated with another presented resource and/or the widget of the other presented resource can be used by a policy to determine whether a condition specified by an <end/> element or an analog is met. A “parent-event” attribute may be used to specify an event associated with a parent widget that specifies a condition for ending the presentation of the resource, including a markup element such as <end parent-event=“on Close”/>. Policies that are set in an application such as the browser 304 and/or user-specified polices can be used to set defaults for attributes that are not specified. In some embodiments, policies may be set that override attribute settings. For example, a policy can be configured to indicate that a widget presenting an XHMTL-based page including an <end/> element is to be closed after is has been displayed for a specified period of time. A policy can be configured to indicate that an end condition is met for a resource including an <end/> element or an analog when an event related to the widget occurs, such as the widget loses focus. Alternately or in addition to the policy, an “event” attribute can be used to accomplish essentially the same function. For example, the element <end event=“endFocus”/> can indicate that the widget presenting the resource is to be closed when an event indicating the widget has lost the display focus is received.

In another aspect, detecting a markup element in block 102 includes detecting a markup element defined to specify at least one of a length of time before automatically closing the first widget, a time at which to automatically close the first widget, and an event to monitor such that occurrence of the event provides indication for automatically closing the first widget. For example, the markup detector component 202 can be configured for detecting a markup language element that is defined to specify at least one of a length of time before automatically closing the first widget, a time at which to automatically close the first widget, and an event to monitor such that occurrence of the event provides indication for automatically closing the first widget. In example, the following exemplary time-based attributes can be used to further specify time-based conditions for automatically closing a widget: <end time=“10 ms”/>, <end time=“13:25”/>, <end time=“10 ms” event=“on ParentClose”/>, and <end time=“10 ms” event=“on MouseOver”/>. In the first example, the widget is to be closed 10 milliseconds after the initial presentation of the content of the resource. In the second example, the widget is to be closed at 1:25 PM. In the third example, the widget is to be closed 10 milliseconds after detecting the closing of a parent resource's widget. In the fourth example, the widget is to be closed 10 milliseconds after a “mouse over” event is detected that is associated with the widget.

The “event” attribute can be used in conjunction with a time attribute, as shown, or other attribute types, and/or can be used alone. Attributes related to other elements in the resource or in an associated resource, and attributes related to an associated widget may also be used. For example, closing a widget may depend on a specific element detected within the content of the resource or a related resource or the number of times the specified element occurs. More particularly, automatic closing of widgets can be based on the number of <p> elements, for example, in an HTML markup-based resource. More <p> elements usually indicates more text to be read, thus this fact can be used as an indication that the page should be displayed longer. The element may be specified as <end countElement=“<p>” time=“10 s”/> indicating the resource should be displayed 10 seconds times the number of <p> elements in the resource. Closing the widget can depend on attributes of the application performing the presentation, such as browser type and version. For example, instead of including script instructions to detect whether a browser instance is compatible with content to be displayed, an <end client=“list of compatible clients with version information”/> including a “client” attribute for providing a list of compatible clients can be supported. When a markup language based resource is to be presented with this element included, a widget for presenting the resource is closed before any content is rendered in one example. Alternately, an attribute indicating incompatible clients can be used to perform essentially the same function.

An <end/> element can have a message attribute in one aspect where the value of the message attribute is displayed as a message automatically prior to, during, or after the automatic closing of the widget. Attribute values including the message attribute value may be specified by reference, thus allowing them to be maintained separate from the resource. For the message attribute, this allows a message compatible with the language of the device or the application to be retrieved and used.

An <end/> element or an analog as indicated can be supported in markup languages that support graphics and audio, such as in synchronized multimedia integration language (SMIL), virtual reality modeling language (VRML), X3D, in the metadata stream of a video and/or audio stream such as an MPEG stream. For streaming media, the <end/> element may occur in any portion of the stream from beginning to end. In one example, a detection of an <end/> element or an analog indicates the widget presenting the stream content is to be closed immediately.

The system 300 illustrated in FIG. 3 depicts a device 302 including a browser 304 operating within an operating environment provided by the device 302. The execution environment, in one embodiment, includes a processor, processor memory, secondary storage, input/output devices, a network adapter, an operating system or control program, a networking subsystem, an input subsystem, and one or more presentation subsystems for presenting text, graphics, audio, and/or tactile output. The browser 304 includes a number of content handlers 210 including the HTML content handler 210a, an XMPP-IM content handler 210b for presence and instant message markup-language-based content, a video content handler 210c for processing MPEG video streams including markup language elements, and an image content handler 210d for processing JPEG image data including markup language elements. The content handlers 210 are illustrative and are not intended to constitute an exhaustive list.

In system 300, a resource is received, for example, by a content handler 210 from a server, such as a network server 306. The resource is sent in a message from the server 306 via a network 308 and received by the device 302 via a network stack 310 including both a network adapter and associated software. The message can be passed through an application protocol layer such an HTTP layer 312 or an XMPP-IM layer 314 depending on the server 306 and the browser 304. The message is received via the browser 304 by a content manager 316 that determines a MIME type associated with at least a portion of the message. The content manager 316 uses the determined MIME type to route the message, or a portion of it, to a compatible content handler 210 that receives the content including a markup language element while processing the markup language based content for a presentation of the resource. The receiving content handler 210 communicates with a presentation controller 318 to present the content. Visual content is displayed using a display subsystem 320 of the device 302 under the direction of the presentation controller 318. Audio content, tactile content, and/or content supported by other modes are displayed by an audio subsystem, a touch subsystem, and/or other subsystem compatible with the presentation mode of the resource, respectively.

Returning to FIG. 1, in block 104 it is determined whether the condition for automatically closing the first widget is satisfied. This determination is made without using executable code included in the resource. Accordingly, a system for providing for automatically closing application widgets based on markup language elements includes means for determining, without using executable code included in the resource, whether the condition for automatically closing the first widget is satisfied. For example, as illustrated in FIG. 2, the content controller component 204 is configured for determining, without using executable code included in the resource, whether the condition for automatically closing the first widget is satisfied.

In one aspect, a DOM element object associated with the received element is used for determining whether the condition for automatically closing the first widget is satisfied. For example, the content controller component 204 can be configured for determining whether the condition for automatically closing the first widget is satisfied by determining a DOM element object associated with the received markup language element. The content controller component 204 associates an element condition object 214 with a detected element. Such an association can be made, for example, using a DOM based on an object oriented programming language. In the current example, the element condition object 214 is associated with the <end/> element and maintains information about the element and can provide access to, for example, its name, attributes, and location within a resource. In addition, the element condition object 214 can be accessed by the content controller component 204 to determine whether the condition for closing the widget presenting the resource as specified by the <end/> element and its attributes, if any, is met.

In another aspect, determining whether the condition for automatically closing the first widget is satisfied in block 104 includes retrieving information indicated by the received element and determining based on the retrieved information whether the condition for automatically closing the widget is satisfied. For example, the content controller component 204 can be configured for determining whether the condition for automatically closing the first widget is satisfied by retrieving information indicated by the markup language element and determining based on the retrieved information whether the condition for automatically closing the first widget is satisfied. In an example, the element condition object 214 can specify the information it needs to the content controller component 204. The content controller component 204 monitors input associated with the presentation of the resource via an input controller 216 included in the content handler 210a. The input controller 216 receives input routed to it, for example by the system input controller 322 of the browser 304 as received via the input subsystem 324 of the device 302 depicted in FIG. 3. The content controller component 204 uses the content model 212 to maintain and/or determine attributes of the resource, such as element counts and content size(s). If the resource is updatable during presentation, the content controller component 204 can also detect updates and report relevant updates to the element condition object 214.

In another aspect, determining whether the condition for automatically closing the first widget is satisfied includes receiving user input to a form associated with the resource. For example, the content controller component 204 can be configured for receiving user input to a form associated with the resource via the path described above. A condition may be associated with an input to a form included as at least a portion of the resource. The content controller component 204 can use a forms manager 218 to detect form input and form changes. Changes relevant to an element condition manager 214 as specified to the content controller component 204 are reported to the element condition manager 214 as detected.

A condition can be based on an attribute and/or an event associated with a request generated in association with the presented resource. For example, an end condition can be specified such that the associated presentation of the resource is ended when a command to build a request is detected by the content controller component 204. Similarly, an end condition can be specified such that the condition is met when a request has certain attributes. For example, an end condition may be specified that is met when the request is an HTTP GET request. In another example, a condition may be specified as met when a command is sent. The content controller component 204 of the system 200 communicates with a request builder 220 for detecting request related information needed by the element condition object 214.

For information associated with other resources managed by the same content handler 210 the content handler 210 can use resource IDs to distinguish each resource, its content model, and element object condition. A resource can include more than one <end/> element or analog and thus have more than one element condition object 214 instance associated with it by the content controller component 204.

For information associated with resources handled by other content handlers 210, the content controller component 204 provides an indication to the content manager 316 that identifies the associated resources and information required in order to make the determination as to whether an end condition is met. The content manager 316 communicates with other content handlers 210 and with other components of the browser 304 in order to detect, gather, and provide the requested information to the requesting content handler 210.

As the content controller component 204 receives the requested information, it determines whether a condition specified by, in the current example, the <end/> element is met at appropriate times with respect to the content and/or the application. In some cases, determination is made on a substantially continual basis as requested data is received. In other cases, the determination is made when explicitly requested by the content controller component 204. Alternately or additionally, the determination can be made when a specified minimum set of information has been received by the element condition object 214.

The element condition object 214 and the other components described in the process of providing information used in determining whether a condition for automatically closing a widget presenting the resource associated with the <end/> element are all components of the browser 304 or may be plug-ins or other executables resident in the device 302. No script instructions in the resource or referenced via a link in the resource are required for determining whether the condition is met.

Returning to FIG. 1, in block 106 the first widget is automatically closed responsive to the condition for automatically closing the first widget being satisfied. Accordingly, a system for providing for automatically closing application widgets based on markup language elements includes means for automatically closing the widget responsive to the condition for automatically closing the widget being satisfied. For example, as illustrated in FIG. 2, the presentation manager component 208 is configured for automatically closing the widget responsive to the condition for automatically closing the first widget being satisfied.

When a condition for automatically closing the widget presenting the resource is determined to be met by the content controller component 204, the content controller component 204 instructs the presentation manager component 208 to close the widget presenting the resource. The presentation manager component 208 closes the widget to end the presentation of the resource by the display subsystem 320 or other output subsystem via communication with the presentation controller 318. If the resource is included in another resource and/or associated with another resource via a relationship, such as a parent-child relationship, the content manager 316 determines which, if any, other content handlers 210 require instruction and/or information and coordinates the interoperation of the content handlers 210 in closing the widget presenting the resource.

In one aspect, a second widget is automatically closed responsive to the condition for automatically closing the first widget being satisfied. For example, the presentation manager component 208 can be configured for automatically closing a second widget responsive to the condition for automatically closing the first widget being satisfied. For example, a child resource of the resource displayed in a second widget can also be closed. Similarly, a widget containing parent resource may be closed. The content manager 316 can be notified prior to the closing of the widget, thus allowing the content manager 316 to coordinate closing widgets with other resources. Alternatively, the content manager 316 can be informed after or during the closing of the widget.

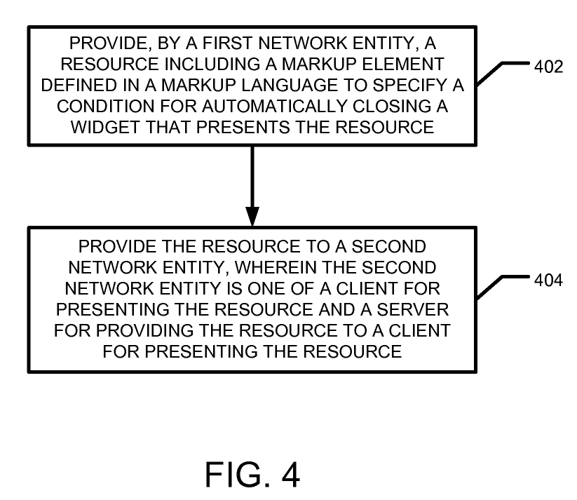

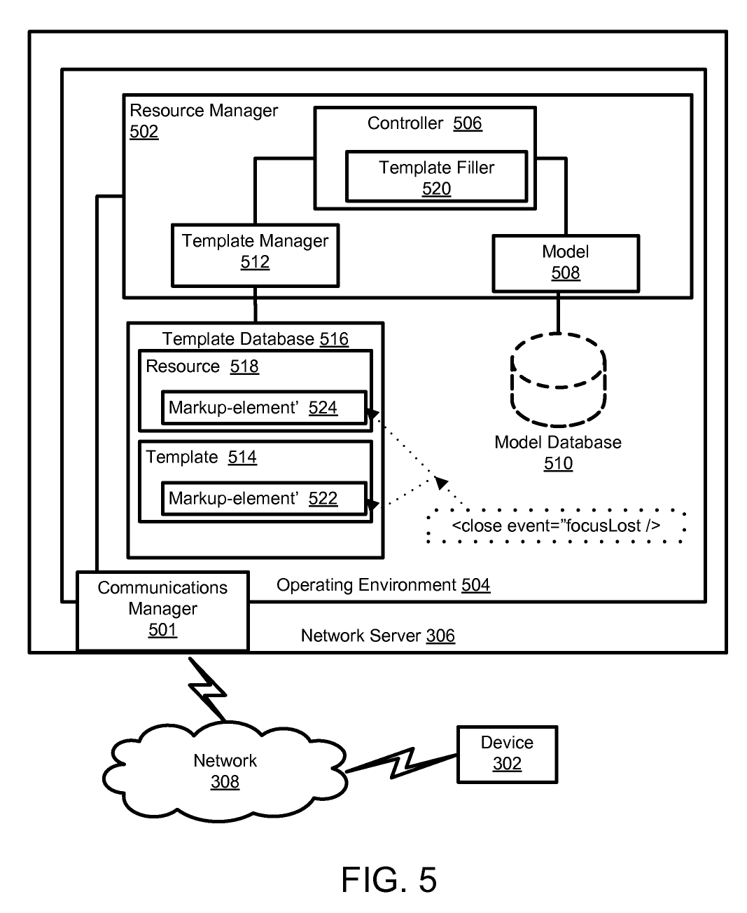

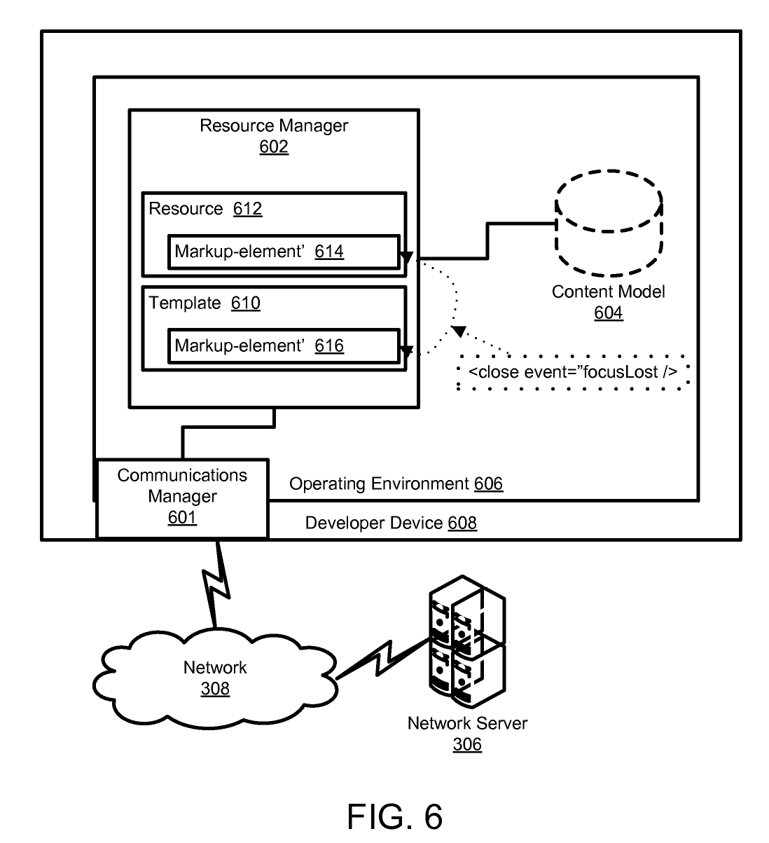

FIG. 4 is a flow diagram illustrating a method for providing for automatically closing application widgets based on markup language elements according to an exemplary embodiment of the subject matter described herein. FIG. 5 is a block diagram illustrating a system for providing for automatically closing application widgets based on markup language elements according to another exemplary embodiment of the subject matter described herein. The method illustrated in FIG. 4 can be carried out by, for example, some or all of the components illustrated in the exemplary systems of FIG. 5 and/or FIG. 6.

Once again, the systems illustrated by FIGS. 5 and 6 are described by way of example in terms of web based markup languages including variants of HTML and XML. It should, however, be understood that many markup languages exist for creating text based content and media based content including audio and image based content. In addition, a number of markup languages can be used together in specifying a presentable resource.

With reference to FIG. 4, in block 402 a first network entity provides a resource including a markup element defined in a markup language to specify a condition for automatically closing a widget that presents the resource. Accordingly, a system for providing for automatically closing application widgets based on markup language elements includes means for providing, by a first network entity, a resource including a markup element defined in a markup language to specify a condition for automatically closing a widget that presents the resource. For example, as illustrated in FIG. 5, a resource manager component 502 is configured for providing a resource including a markup element defined in a markup language to specify a condition for automatically closing a widget that presents the resource.

In one aspect, providing a resource includes providing the resource in response to a request received from the client. For example, the resource manager component 502 can be configured for providing the resource in response to a request received from the client. The first network entity may be the network server 306 illustrated in FIG. 3 and a request can be received from the browser 304 of the device 302. The request is received by the resource manager component 502 operating within an operating environment 504 of the network server 306 via the communications manager component 501, such as a network interface. The message is transmitted over the network 308 from the device 302 to the resource manager component 502. The resource manager component 502, for example, can be an FTP application, an instant messaging application, a presence application, and/or an email application. In a current example, the resource manager component 502 is described in terms of an application operating in the operating environment 504 of a network server 306 and optionally a network server application container such as a J2EE container (not shown). The execution environment, for example, can include a processor, processor memory, secondary storage, an operating system or control program, and a communication subsystem.

Messages received by the resource manager component 502 are routed to a controller 506, for example a Java servlet, based on an identifier in the request, for example, a URI or a portion of a URI. The controller 506 uses the identifier and any additional information included in the request along with associated information, such as session information associated with a resource manager component 502, to determine an appropriate response. The controller 506 is configured to process the request and provide a resource including the markup element defined in a markup language to specify a condition for automatically closing a widget that presents the resource.

The controller 506, in determining the appropriate response to the received request, can also determine a data model that provides data for building a response. The data model is accessed via a model 508 that matches the determined response. There can be many models 508 in the resource manager component 502, as different requests correspond to different responses associated with different data requirements. Once the appropriate model 508 is determined, the controller 506 provides the model 508 with information received in and/or associated with the request. The model 508 retrieves and/or generates the data associated with the particular model and returns the data to the controller 506. Retrieved data in the system 500 is stored in a model database 510. The controller 506, in determining the appropriate response, also determines an appropriate format for the response that will include at least a portion of the model data.

In another aspect, providing a resource in block 402 includes providing a template combined with a pre-generated resource, where the template includes the markup language element. For example, the resource manager component 502 can be configured for providing a resource by providing a template combined with a pre-generated resource, where the template includes the markup language element.

The controller 506 provides a template manager 512 with information included in and/or associated with the request. The template manager 512 determines a template for use in generating a response to the received request. In one example, the template can be filled, at least in part, using data included in the data model returned by the model 508. The template manager 512 retrieves a template 514 from a template database 516. In another example, the template 514 can be combined with a pre-generated resource 518 such an image, a video, or a text resource, where at least a portion of the pre-generated resource 518 is markup-language-based.

The template 514 and optionally the pre-generated resource 518 are returned to the controller 506 for generating the resource to be returned in the response. The controller 506 provides the template 514 and the optional pre-generated resource 518 to a template filler 520 along with the data provided by the model 508. The template filler 520 generates the resource using the data to complete the template 514.

In another aspect, providing a resource in block 402 includes generating the resource by a content provider and forwarding the resource to a content distributor via a network. For example, FIG. 6 depicts an alternative arrangement for providing a resource including a markup element defined in a markup language to specify a condition for automatically closing a widget that presents the resource. In FIG. 6, a resource manager component 602 is operable within an operating environment 606 of a developer device 608 and is configured for providing a resource including a markup element defined in a markup language to specify a condition for automatically closing a widget that presents the resource. The resource manager component 602 can be configured for providing a resource by generating the resource and forwarding the resource to a content distributor via a network. For example, the resource manager component 602 can be a resource editor for generating resources having markup elements. Resource editors are well-known in the art. Examples include MICROSOFT CORPORATION's FRONTPAGE and ADOBE CORPORATION's DREAMWEAVER. According to this aspect, the resource manager component 602 can use a markup language whose schema has been extended to include a markup language element defined for specifying a condition for automatically ending the presentation of a markup language based resource using the markup language element.

As the resource manager component 602 constructs a resource, a model of the resource including its content, if any, is managed by a content model 604, such as a DOM, as previously discussed. The resource manager component 602 and the content model 604 operate within the operating environment 606 provided by a developer device 608. The operating environment 606 includes, for example, a processor, processor memory, secondary storage, and an input/output system supporting devices such as a display, a keyboard, a mouse, and a disk driver. A communication manager component 601 provides a generated resource to be transmitted to a device, such as the network server 306 via the network 308 for use in a network application such as the resource manager component 502.

As the resource manager component 602 receives input associated with the resource, commands are issued to the content model 604. The content model, in one aspect, uses a specified schema to validate any updates, additions, and deletions made to the resource. The schema is used by other applications to parse and present the resource. In the embodiment shown, a template 610 compatible with the markup language in use can be used in the editor to simplify the creation of the resource. Additionally, a pre-generated resource 612 may be used in the editor as well, where the pre-generated resource 612 includes markup that is compatible with the schema of the resource being generated.

The content model 604 stores the generated resource in a format compatible with the schema in secondary storage (not shown) or provides the formatted resource including markup language elements to the resource manager component 602.

Returning to FIG. 4, in block 404 the resource is provided to a second network entity that is one of a client for presenting the resource and a server for providing the resource to a client for presenting the resource. Accordingly, a system for providing for automatically closing application widgets based on markup language elements includes means for providing the resource to a second network entity that is one of a client for presenting the resource and a server for providing the resource to a client for presenting the resource. For example, as illustrated in FIGS. 5 and 6, a communications manager component 501, 601 can be configured for providing the resource to a second network entity that is one of a client for presenting the resource and a server for providing the resource to a client for presenting the resource.

For example, as illustrated in FIG. 5, the resource can be provided to a device 302 for presenting the resource, and/or as illustrated in FIG. 6, the resource can be provided to a network server 306 for providing the resource to a client for presenting the resource. By way of example, in the exemplary system illustrated in FIG. 5, after the resource including the markup element is generated, the template filler 520 provides the resource to the content controller 506. The content controller 506 provides the resource to the communications manager component 501 for forwarding to the device 302 by sending a response to the received request via the network 308. The device can be enabled as describe above to present the resource via an output subsystem compatible with the resource type. As described with respect to FIGS. 1, 2, and 3, a content handler 210 of the browser is able to determine whether the condition specified by the markup language element is met without using executable code included in the markup language base resource. When the condition is determined to be met, a content handler 210 interoperating with the content manager 316 is capable of closing a widget that is presenting the resource, such as a window.

In the system illustrated in FIG. 6, the resource manager component 602 is configured to provide the resource to communications manager component 601 to forward the resource to a network server 306, which can then forward the resource to a device via the network 308 as described above.

The content model 604 provides the resource in a format that is presentable by a number of applications. For example, if the markup language is an HTML variant, SMIL, and/or X3D, then browsers are capable for presenting the output. The content model 604 of the resource manager component 602 can store the resource in a storage location accessible by an application capable of performing the method defined in FIG. 1 or accessible by a network application capable of providing the resource via the network 308 in a response to a request from a device, such as device 302. In an alternative aspect, the communications manager component 601 can transmit the resource to a device 302 via network 308.

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions that can be performed by elements of a computer system. For example, it will be recognized that the various actions can be performed by specialized circuits or circuitry (e.g., discrete logic gates interconnected to perform a specialized function), by program instructions being executed by one or more processors, or by a combination of both.

Moreover, executable instructions of a computer program for carrying out the methods described herein can be embodied in any machine or computer readable medium for use by or in connection with an instruction execution machine, system, apparatus, or device, such as a computer-based or processor-containing machine, system, apparatus, or device, that can read or fetch the instructions from the machine or computer readable medium and execute the instructions.

As used here, a “computer readable medium” can be any means that can contain, store, communicate, propagate, or transport the computer program for use by or in connection with the instruction execution machine, system, apparatus, or device. The computer readable medium can be, for example, but not limited to, an electronic, magnetic, optical, electromagnetic, infrared, or semiconductor machine, system, apparatus, device, or propagation medium. More specific examples (a non-exhaustive list) of the computer readable medium can include the following: a wired network connection and associated transmission medium, such as an ETHERNET transmission system, a wireless network connection and associated transmission medium, such as an IEEE 802.11(a), (b), or (g) or a BLUETOOTH transmission system, a wide-area network (WAN), a local-area network (LAN), the Internet, an intranet, a portable computer diskette, a random access memory (RAM), a read only memory (ROM), an erasable programmable read only memory (EPROM or Flash memory), an optical fiber, a portable compact disc (CD), a portable digital video disc (DVD), and the like.

Thus, the subject matter described herein can be embodied in many different forms, and all such forms are contemplated to be within the scope of what is claimed. It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for providing for automatically closing application widgets based on markup language elements, the method comprising:
detecting, while processing a resource for presentation in a first widget, a markup element defined in a markup language to specify a condition for automatically closing the first widget;
determining, without using executable code included in the resource, whether the condition for automatically closing the first widget is satisfied; and
automatically closing the first widget responsive to the condition for automatically closing the first widget being satisfied.

2. The method of claim 1 wherein detecting a markup element includes detecting at least one of a tag and an attribute for a tag, wherein the at least one of a tag and an attribute for a tag is defined to specify a condition for automatically closing the first widget.

3. The method of claim 1 wherein detecting a markup element includes detecting the markup element through processing a markup-language-based page for presentation in a widget of a browser.

4. The method of claim 1 wherein detecting a markup element includes detecting a markup element through processing a streaming media resource including markup defined in the markup language.

5. The method of claim 1 wherein detecting a markup element includes detecting a markup element that is defined to specify a condition associated with at least one of another markup element in the resource, another presentable resource, another markup element in another resource, and a request associated with the resource.

6. The method of claim 1 wherein detecting a markup element includes detecting a markup element defined to specify at least one of a length of time before automatically closing the first widget, a time at which to automatically close the first widget, and an event to monitor such that occurrence of the event provides indication for automatically closing the first widget.

7. The method of claim 1 wherein detecting a markup element includes detecting a markup element that identifies a policy defining a condition for automatically closing the first widget.

8. The method of claim 7 wherein the policy is user-specified.

9. The method of claim 1 wherein determining whether the condition for automatically closing the first widget is satisfied includes receiving user input to a form associated with the resource.

10. The method of claim 1 wherein determining whether the condition for automatically closing the first widget is satisfied includes determining a document object model (DOM) element object associated with the received element.

11. The method of claim 1 wherein determining whether the condition for automatically closing the first widget is satisfied includes retrieving information indicated by the received element and determining based on the retrieved information whether the condition for automatically closing the first widget is satisfied.

12. The method of claim 1 further comprising automatically closing a second widget responsive to the condition for automatically closing the first widget being satisfied.

13. A method for providing for automatically closing application widgets based on markup language elements, the method comprising:
providing, by a first network entity, a resource including a markup element defined in a markup language to specify a condition for automatically closing a widget that presents the resource; and
providing the resource to a second network entity, wherein the second network entity is one of a client for presenting the resource and a server for providing the resource to a client for presenting the resource.

14. The method of claim 13 wherein providing a resource includes generating the resource by a content provider and forwarding the resource to a content distributor via a network.

15. The method of claim 13 wherein providing a resource includes providing the resource in response to a request received from the client.

16. The method of claim 13 wherein providing a resource includes providing a template combined with a pre-generated resource, wherein the template includes the markup language element.

17. A system for providing for automatically closing application widgets based on markup language elements, the system comprising:
means for detecting, while processing a resource for presentation in a first widget, a markup element defined in a markup language to specify a condition for automatically closing the first widget;
means for determining, without using executable code included in the resource, whether the condition for automatically closing the first widget is satisfied; and
means for automatically closing the first widget responsive to the condition for automatically closing the first widget being satisfied.

18. A system for providing for automatically closing application widgets based on markup language elements, the system comprising:
a markup detector component configured for detecting, while processing a resource for presentation in a first widget, a markup element defined in a markup language to specify a condition for automatically closing the first widget;
a content controller component configured for determining, without using executable code included in the resource, whether the condition for automatically closing the first widget is satisfied; and
a presentation manager component configured for automatically closing the first widget responsive to the condition for automatically closing the first widget being satisfied.

19. The system of claim 18 wherein the markup detector component is configured for detecting at least one of a tag and an attribute for a tag, wherein the at least one of a tag and an attribute for a tag is defined to specify a condition for automatically closing the first widget.

20. The system of claim 18 wherein the markup detector component is configured for detecting a markup element through processing a markup-language-based page for presentation in a widget of a browser.

21. The system of claim 18 wherein the markup detector component is configured for detecting a markup language element through processing a streaming media resource including markup defined in the markup language.

22. The system of claim 18 wherein the markup detector component is configured for detecting a markup language element that is defined to specify a condition associated with at least one of another markup language element in the resource, another presentable resource, another markup language element in another resource, and a request associated with the resource.

23. The system of claim 18 wherein the markup detector component is configured for detecting a markup language element that is defined to specify at least one of a length of time before automatically closing the first widget, a time at which to automatically close the first widget, and an event to monitor such that occurrence of the event provides indication for automatically closing the first widget.

24. The system of claim 18 wherein the markup detector component is configured for detecting a markup language element that identifies a policy defining a condition for automatically closing the first widget.

25. The system of claim 24 wherein the policy is user-specified.

26. The system of claim 18 wherein the content controller component is configured for determining whether the condition for automatically closing the first widget is satisfied by receiving user input to a form associated with the resource.

27. The system of claim 18 wherein the content controller component is configured for determining whether the condition for automatically closing the first widget is satisfied by determining a DOM element object associated with the received markup language element.

28. The system of claim 18 wherein the content controller component is configured for determining whether the condition for automatically closing the first widget is satisfied by retrieving information indicated by the markup language element and determining based on the retrieved information whether the condition for automatically closing the first widget is satisfied.

29. The system of claim 18 wherein the presentation manager component is configured for automatically closing a second widget responsive to the condition for automatically closing the first widget being satisfied.

30. A system for providing for automatically closing application widgets based on markup language elements, the system comprising:
means for providing, by a first network entity, a resource including a markup element defined in a markup language to specify a condition for automatically closing a widget that presents the resource; and
means for providing the resource to a second network entity, wherein the second network entity is one of a client for presenting the resource and a server for providing the resource to a client for presenting the resource.

31. A system for providing for automatically closing application widgets based on markup language elements, the system comprising:
a resource manager component configured for providing, by a first network entity, a resource including a markup element defined in a markup language to specify a condition for automatically closing a widget that presents the resource; and
a communications manager component configured for providing the resource to a second network entity, wherein the second network entity is one of a client for presenting the resource and a server for providing the resource to a client for presenting the resource.

32. The system of claim 31 wherein the resource manager component is configured for providing a resource by generating the resource and forwarding the resource to a content distributor via a network.

33. The system of claim 31 wherein the resource manager component is configured for providing the resource in response to a request received from the client.

34. The system of claim 31 wherein the resource manager component is configured for providing a resource by providing a template combined with a pre-generated resource, wherein the template includes the markup language element.

35. A computer readable medium including a computer program, executable by a machine, for providing for automatically closing application widgets based on markup language elements, the computer program comprising executable instructions for:
detecting, while processing a resource for presentation in a first widget, a markup element defined in a markup language to specify a condition for automatically closing the first widget;
determining, without using executable code included in the resource, whether the condition for automatically closing the first widget is satisfied; and
automatically closing the first widget responsive to the condition for automatically closing the first widget being satisfied.

36. A computer readable medium including a computer program, executable by a machine, for providing for automatically closing application widgets based on markup language elements, the computer program comprising executable instructions for:
providing, by a first network entity, a resource including a markup element defined in a markup language to specify a condition for automatically closing a widget that presents the resource; and
providing the resource to a second network entity, wherein the second network entity is one of a client for presenting the resource and a server for providing the resource to a client for presenting the resource.
